(19) United States
(12) Patent Application Publication
(10) Pub. No.: US 2015/0222569 A1
(43) Pub. Date: Aug. 6, 2015

(54) Information transmission network and corresponding functional node

(71) Applicants: THALES, NEUILLY SUR SEINE (FR); SYSTEMES EMBARQUES AEROSPATIAUX, PARIS (FR)

(72) Inventors: Augustin MIGNOT, MEUDON LA FORET (FR); Alexis DUBROVIN, MEUDON LA FORET (FR); Patrice TOlLLON, MEUDON LA FORET (FR); Paul ORTAIS, PARIS (FR)

(21) Appl. No.: 14/663,875

(22) Filed: Mar. 20, 2015

Related U.S. Application Data
(63) Continuation of application No. PCT/EP2013/069508, filed on Sep. 19, 2013.

(30) Foreign Application Priority Data
Sep. 21, 2012 (FR) 12 02526

(51) Int. Cl. H04L 12/947; H04L 12/721

(52) U.S. Cl. CPC H04L 49/25; H04L 45/66

(57) ABSTRACT

An information transmission network and corresponding functional node are disclosed. In one aspect, the information transmission network includes functional nodes connected to one another by an information transmission capability. The information is in the form of discrete messages propagating from node to node in the network. At least some of the nodes have at least two operating modes, one operating mode defined only by the configuration of the physical layer of the node referred to as 1 of the OSI model and one operating mode defined at least by that layer and the link layer of the node referred to as 2 of the OSI model.

### CROSS-REFERENCE TO RELATED APPLICATIONS

This application is a continuation of International Application No. PCT/EP2013/069508, filed Sep. 19, 2013, which claims benefit under 35 U.S.C. §119 of French Application No. 12 02526, filed Sep. 21, 2012, which are herein incorporated by reference in their entirety.

### BACKGROUND

1. Field

The described technology generally relates to an information transmission network and a corresponding functional node.

More particularly, the described technology generally relates to one such information transmission network that comprises functional nodes connected to each other by an information transmission capability, wherein the information assumes the form of discrete messages propagated from node to node in the network.

2. Description of the Related Technology

It is for example possible to define, in some of these networks among these nodes, functional nodes that are in fact made up of nodes for distributing information in the network.

These distribution nodes are then for example associated with nodes for transmitting and/or receiving information in the network.

Such networks have a certain number of drawbacks, in particular in terms of their operating security/reliability in certain situations.

Thus, in case of malfunction of the node, for example, this may cause the complete loss of the network.

### SUMMARY OF CERTAIN INVENTIVE ASPECTS

One objective of some aspects of the described technology is to resolve these problems.

To that end, one inventive aspect is an information transmission network comprising functional nodes connected to one another by an information transmission capability, wherein the information is in the form of discrete messages propagating from node to node in the network, wherein at least some of the nodes have at least two operating modes, one operating mode defined only by the configuration of the physical layer of the node referred to as 1 of the open systems interconnection (OSI) model, and one operating mode defined at least by that layer and the link layer of the node referred to as 2 of the OSI model.

Additional aspects of the network, considered alone or in combination, include:
the node(s) are nodes for distributing information in the network;
the distribution nodes are associated with nodes for transmitting and/or receiving information in the network;
said operating mode of the nodes defined by the configuration of their physical layer referred to as 1 of the OSI model is a downgraded operating mode of the node, activated in case of failure thereof;
said operating mode of the nodes defined by the configuration of their physical layer referred to as 1 of the OSI model is a regular operating mode of the node, activated by a triggering capability;
said triggering capability is an internal or external capability with respect to the node;
the configuration of the physical layer is frozen;
the configuration of the physical layer is programmable;
the operating mode of the node defined by the configuration of the physical layer referred to as 1 of the OSI model includes at least the distribution/non-distribution configuration for information by at least some of the ports of the node;
the distribution/non-distribution configuration for information by the other ports of the node is defined by their physical layer referred to as 1 and by their link layer referred to as 2 of the OSI model; and
the functional nodes are connected in at least one loop by the information transmission capability, the information propagating unconditionally from node to node in the network.

Another aspect also relates to a corresponding functional node.

### BRIEF DESCRIPTION OF THE DRAWINGS

The described technology will be better understood upon reading the following description, provided solely as an example and done in reference to the appended drawings, in which:

FIG. 1 shows an example embodiment of an information transmission network structure; and

FIG. 2 illustrates the different layers of the OSI reference model.

### DETAILED DESCRIPTION OF CERTAIN INVENTIVE EMBODIMENTS

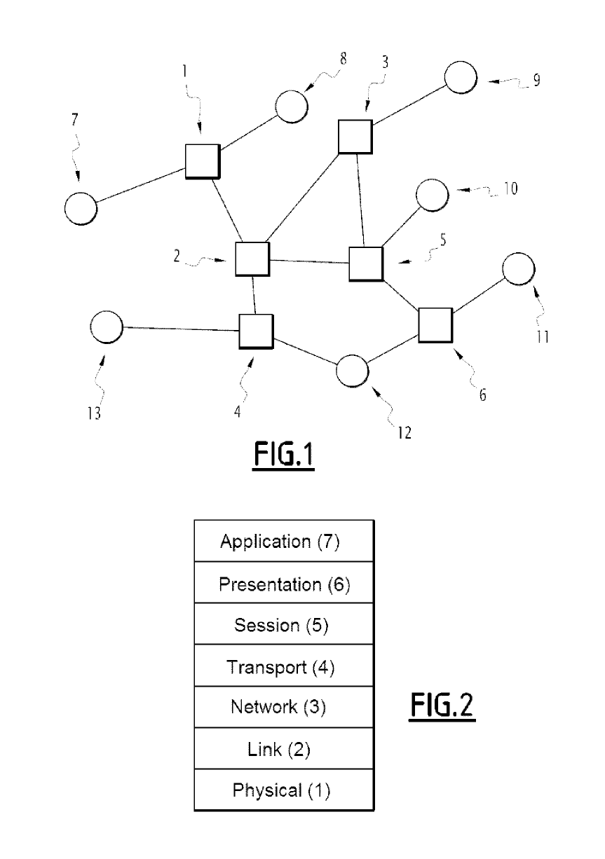

FIG. 1 in fact illustrates an example information transmission network.

This network may for example be an information transmission network onboard an aircraft or other capability.

This network then comprises a certain number of functional nodes connected to each other by an information transmission capability.

The information for example, in a manner known in itself, takes the form of discrete messages propagating from node to node in this information transmission network.

In fact, it is possible to distinguish, among the nodes illustrated this network, distribution nodes for distributing information in the network, for example designated by references 1, 2, 3, 4, 5 and 6 in FIG. 1.

These distribution nodes are for example associated, as illustrated, with nodes for transmitting and/or receiving information in the network, for example such as the nodes 7, 8, 9, 10, 11, 12 and 13.

At least some of the nodes of the network, and in particular the nodes 1 to 6 for distributing information in the network previously described, have at least two operating modes, including an operating mode uniquely defined by the configuration of their physical layer referred to as 1 of the OSI model and an operating mode defined at least by that layer and by their link layer referred to as 2 of the OSI model.

FIG. 2 shows a diagram illustrating the different layers of the OSI (Open System Interconnection) model.

This illustrated model is a standard model, such that it will not be described in more detail below.

Traditionally, the layers of this OSI model are distributed between layers respectively numbered from 1 to 7, for the physical layer referred to as 1, the link layer referred to as 2, the network layer referred to as 3, the transport layer referred to as 4, the session layer referred to as 5, the presentation layer referred to as 6 and the application layer referred to as 7.

In the transmission network according to an embodiment, a node, for example a distribution node, has an operating mode uniquely defined by the configuration of its physical layer referred to as 1 of this OSI model.

In fact, this operating mode may for example be a downgraded operating mode of the node, which is activated in case of failure/malfunction thereof.

However, this operating mode defined by the configuration of its physical layer referred to as 1 may also be a regular operating mode of that node, activated by a triggering capability.

The triggering capability may then be an internal and/or external capability with respect to the node, suitable for activating that mode and for example switching the operation of the node in that mode.

The configuration of the physical layer referred to as 1 of the node can then be frozen or programmable.

This operating mode then comprises at least the distribution/non-distribution configuration for information by at least some (if not all) of the ports of the node.

It is in fact known that such nodes comprise information input/output ports.

The distribution/non-distribution configuration for this information by at least some of these ports may then be defined by the configuration of the physical layer referred to as 1 of that node, only.

If this configuration only pertains to some of the ports of the node, then the distribution/non-distribution configuration of the other ports of the node is defined by that physical layer and the link layer referred to as 2 of the OSI model of that node.

According to one embodiment, the information distribution/non-distribution configuration by all of the ports of the node may be defined by the configuration of the physical layer referred to as 1 of that node.

Different embodiments of the information transmission network may of course be considered.

In the described example, a certain number of functional nodes are connected in at least one loop by the information transmission capability, the information then propagating unconditionally from node to node in the network, as described for example in document FR A 2,857,805.

However, other propagation modes may also be considered.

While there have been shown and described and pointed out the fundamental novel features of the invention as applied to certain inventive embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplate. All such modifications and variations are within the scope of the invention as determined by the appended claims when interpreted in accordance with the breadth to which they are entitled.

1-12. (canceled)

13. An information transmission network comprising functional nodes connected to one another by an information transmission capability, wherein the information is in the form of discrete messages propagating from node to node in the network, wherein at least some of the nodes have at least two operating modes, one operating mode defined only by the configuration of the physical layer of the node referred to as 1 of the open systems interconnection (OSI) model, and one operating mode defined at least by that layer and the link layer of the node referred to as 2 of the OSI model.

14. The information transmission network of claim 13, wherein the node(s) are nodes for distributing information in the network.

15. The information transmission network of claim 14, wherein the distribution nodes are associated with nodes for transmitting and/or receiving information in the network.

16. The information transmission network of claim 13, wherein the operating mode of the nodes defined by the configuration of their physical layer referred to as 1 of the OSI model is a downgraded operating mode of the node, activated in case of failure thereof.

17. The information transmission network of claim 13, wherein the operating mode of the nodes defined by the configuration of their physical layer, layer 1 of the OSI model, is a regular operating mode of the node activated by a triggering capability.

18. The information transmission network of claim 17, wherein the triggering capability is an internal or external capability with respect to the node.

19. The information transmission network of claim 13, wherein the configuration of the physical layer is frozen.

20. The information transmission network of claim 13, wherein the configuration of the physical layer is programmable.

21. The information transmission network of claim 13, wherein the operating mode of the node defined by the configuration of the physical layer, layer 1 of the OSI model, includes at least the distribution/non-distribution configuration for information by at least some of the ports of the node.

22. The information transmission network of claim 21, wherein the distribution/non-distribution configuration for information by the other ports of the node is defined by their physical layer, layer 1, and by their link layer, layer 2 of the OSI model.

23. The information transmission network of claim 13, wherein the functional nodes are connected in at least one loop by the information transmission capability, the information propagating unconditionally from node to node in the network.

24. An functional node for a network, the network comprising:
at least one module configured to distribute messages between input and output ports,
wherein the distribution module comprises at least one combination of at least three ports, including a first input port connected to a second output port by a first capability for unconditionally propagating messages, not depending on the messages, and
wherein the first and/or second ports are connected to a third port by a second capability for conditionally propagating messages, depending on the messages.
